(19) United States
(12) Patent Application Publication
(10) Pub. No.: US 2017/0114845 A1
(43) Pub. Date: Apr. 27, 2017

(54) PRE-LUBRICATED DISC BRAKE ASSEMBLY AND METHOD

(71) Applicant: Power Stop, LLC, Bedford Park, IL (US)

(72) Inventors: John NIEMIERA, Palos Park, IL (US); Arvin SCOTT, Chicago, IL (US)

(21) Appl. No.: 15/331,528

(22) Filed: Oct. 21, 2016

Related U.S. Application Data
(60) Provisional application No. 62/245,576, filed on Oct. 23, 2015.

(51) Int. Cl. F16D 65/092

(52) U.S. Cl. CPC F16D 65/092; F16D 2200/0034; F16D 2250/00

(57) ABSTRACT

A method of manufacturing a pre-lubricated disc brake pad is described, including steps of providing a brake pad, applying a lubricant layer to the brake pad at a portion of the brake pad configured to engage with a caliper of a disc brake assembly, and applying a sealant layer to cover the lubricant layer. A pre-lubricated disc brake pad includes a brake lining, a backing plate, and lubricant sealant layers. The backing plate includes a portion configured to engage with a caliper of a disc brake assembly, the lubricant layer is formed on the portion configured to engage with the caliper, and the sealant layer is formed on the lubricant layer so as to form a seal that covers the lubricant layer. A brake repair kit includes the brake pad as described. The method and device are also useful in mechanical applications outside the field of automobile brake assemblies.

### CROSS-REFERENCE TO RELATED APPLICATIONS

Priority is claimed to U.S. Provisional Patent Application No. 62/245,576, filed on Oct. 23, 2015, the contents of which are incorporated by reference herein in their entirety.

### TECHNICAL FIELD

The present disclosure relates generally to methods for pre-lubrication of a metal surface that will abut or be engaged with other surfaces, and to improved devices having such pre-lubrication. In particular, the disclosure relates to improved automobile disc brake pads and disc brake assemblies for automobiles having pre-lubricated components, and an improved method of manufacturing disc brake pads and disc brake assemblies.

### BACKGROUND OF THE INVENTION

Currently, many motor vehicles are equipped with disc brakes, in which a metal, carbon, ceramic or composition disc is rigidly affixed to a car wheel. To cause braking, a pair of brake pads, one on either side of the disc, is pressed onto the surface of the disc, causing friction and slowing the vehicle. A disc brake assembly having a disc to be attached to an automobile wheel is disclosed in prior U.S. Pat. No. 9,038,271, the contents of which are incorporated by reference herein.

One challenge in the design of modern disc brakes is the need to replace the pads and/or discs as the friction causes wear over time. In currently available disc brake systems, the heat of braking is absorbed by the material mass between the two rubbing surfaces of each disc. This heat is dissipated, as the disc spins, through a) air convection on the two rubbing surfaces, b) air convection in ventilation passageways cast into the disc, and c) heat radiation of the two rubbing surfaces, if the surfaces become red hot. A high surface temperature reduces the life and the friction coefficient of a given brake pad dramatically, and is therefore highly undesirable. As such it becomes necessary to replace the pads and/or discs, as the repeated stopping friction causes wear over time. When a replacement assembly is installed in the vehicle it is necessary to lubricate certain points or locations on the assembly elements for smooth operation and to prevent excessive heat, wear, and noise during use. Often the replacement assembly includes a small supply or tube of lubricant. However, the mechanic or technician performing the replacement installation does not always use, or properly apply, the lubricant to the assembly elements where needed, resulting in problems such as excessive wear and excessive noise during a braking event. Thus, improvements to address these problems are needed.

### SUMMARY OF THE INVENTION

To avoid the aforementioned problems, the inventors have developed a method of manufacturing a brake pad that is pre-lubricated. The improved pre-lubricated brake pad is used in a disc brake replacement assembly for replacement of worn disc brake systems or brake pads in automobiles. In a preferred embodiment, the pad is fabricated by a method including the steps of applying a mask to a pad, applying a suitable lubricant on an edge portion of the tab (or “ear”) of a brake pad to form a lubricant layer, and forming a seal over the lubricant layer to hold the lubricant in position. The lubricant application and sealing steps may preferably be performed during manufacturing, and before shipment of the brake pad or use of the brake pad in a brake pad replacement step performed on an automobile. The improved brake pad resolves problems associated with prior art methods and devices arising from lack of proper lubrication, or improperly applied lubricant, between the brake pad and the caliper mount in which it is installed. An improved disc brake assembly incorporating the improved pad provides the improved result. The manufacturing method described herein produces the improved brake pad.

### BRIEF DESCRIPTION OF THE DRAWINGS

Exemplary embodiments are illustrated in referenced drawings. It is intended that the embodiments and figures disclosed herein are to be considered illustrative rather than restrictive:

FIG. 1 is a cross sectional view of a disc brake assembly having a disc attached to an automobile wheel.

FIG. 2 is a front elevational view of a disc brake pad.

FIG. 3 is a rear elevational side view of a disc brake pad.

FIG. 4 is a rear elevational view of a tab area of a disc brake pad with applied protective mask.

FIG. 5 is a rear elevational view of a tab area of a disc brake pad with applied lubricant layer.

FIG. 6 is a rear elevational view of a tab area of a disc brake pad during application of a sealant over the lubricant layer.

FIG. 7 is a rear elevational view of a tab area of a disc brake pad being mounted on a caliper mount.

### DETAILED DESCRIPTION OF THE EMBODIMENTS OF THE INVENTION

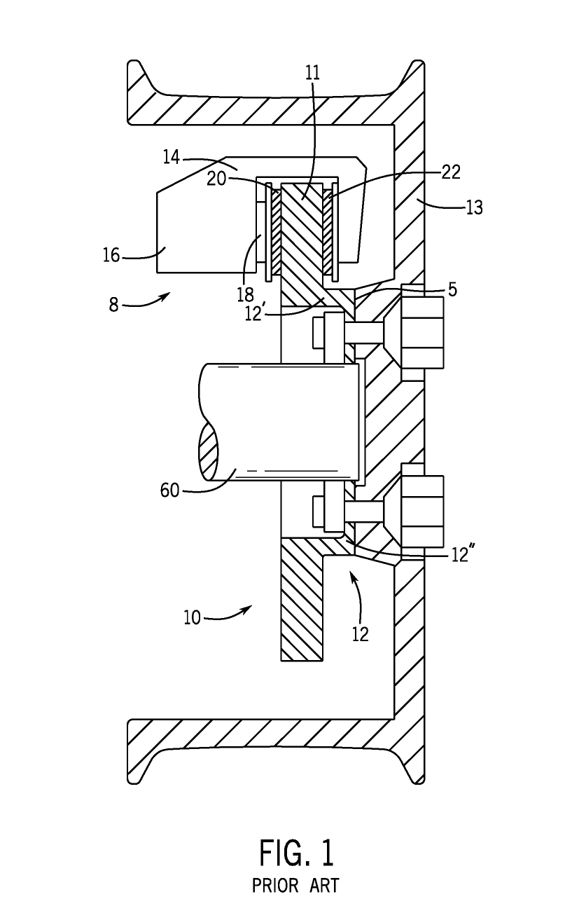

FIG. 1 shows a cross sectional view of a configuration of a typical disc brake assembly for an automobile. A disc brake assembly 8 includes a brake rotor 10, which includes a disc 11 and a mounting hat 12 including a mounting hat side wall 12′, and a mounting hat top wall 12″ mounted on a vehicle wheel 13. The mounting hat top wall 12″ is removably affixed to the wheel by bolts that hold the mounting hat top wall 12″ in a fixed position in relation to the wheel 13 in an operating condition where the wheel 13 is rotating around its bearing hub 60.

A floating caliper 14 is attached to a hydraulic cylinder/piston unit including a piston 18 which reciprocates within the hydraulic cylinder 16 upon pressurization/depressurization of a hydraulic fluid, typically a brake fluid. The pressurization of the hydraulic fluid occurs in response to a request for a braking event that is made by an operator of the automobile, in a known manner. An inner brake pad 20 is mounted on the piston 18, such that when the piston 18 is pushed outwardly relative to the cylinder 16 (toward wheel 13) by the hydraulic action driving the piston/cylinder unit, the inner brake pad 20 contacts the disc 11. This piston movement in turn causes the floating caliper 14 to be pulled inwardly so that an outer brake pad 22, held by floating caliper 14 on the opposite side of the disc 11 from the inner brake pad 20, also contacts disc 11. During the braking event, the inner and outer brake pads 20, 22 pressing against the disc 11 from both of the sides of the disc 11 slow rotation of the disc 11, thereby slowing or stopping the rotation of the disc 11, and thus braking effect is transmitted via the hat 12 to the wheel 13 to which the hat 12 is connected.

It is appreciated from this arrangement that the brake pads 20, 22 are subject to wear due to friction between the disc 11 and the two respective pads 20, 22 positioned on the opposite sides of the disc 11. Brake pad 20 (hereinafter referred to as reference numeral 20 of the inner pad, although the entire discussion herein applies equally to outer pad 22) must be periodically replaced. Replacement brake pads 20 are typically sold separately or as parts of kits, such as a brake pad/rotor replacement kit, which may typically include new inner and outer pads, a new rotor, and a brake lubricant for maintenance and lubrication of the caliper parts during the replacement process.

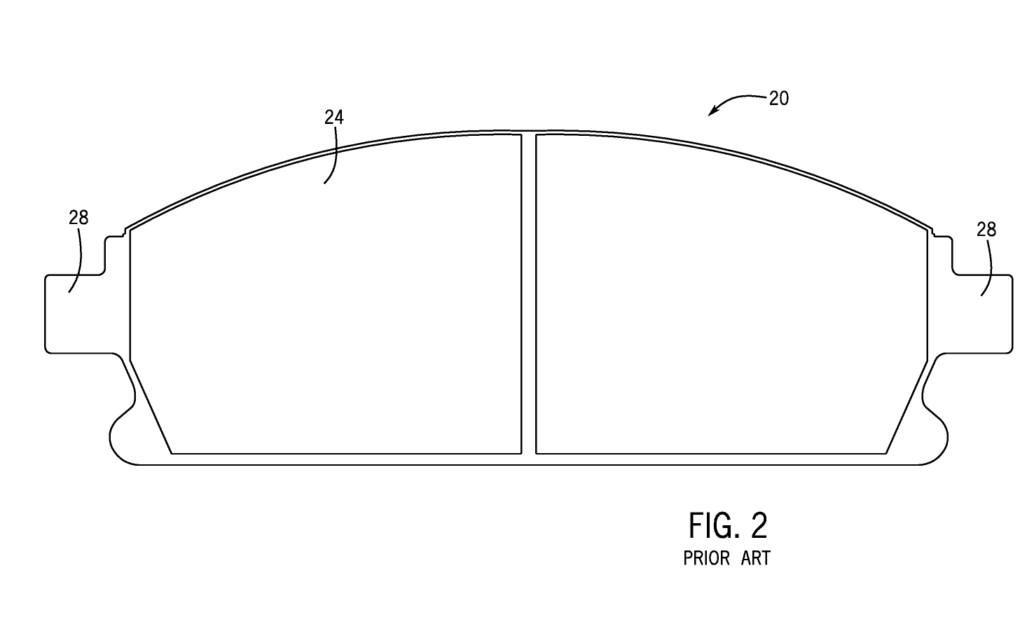

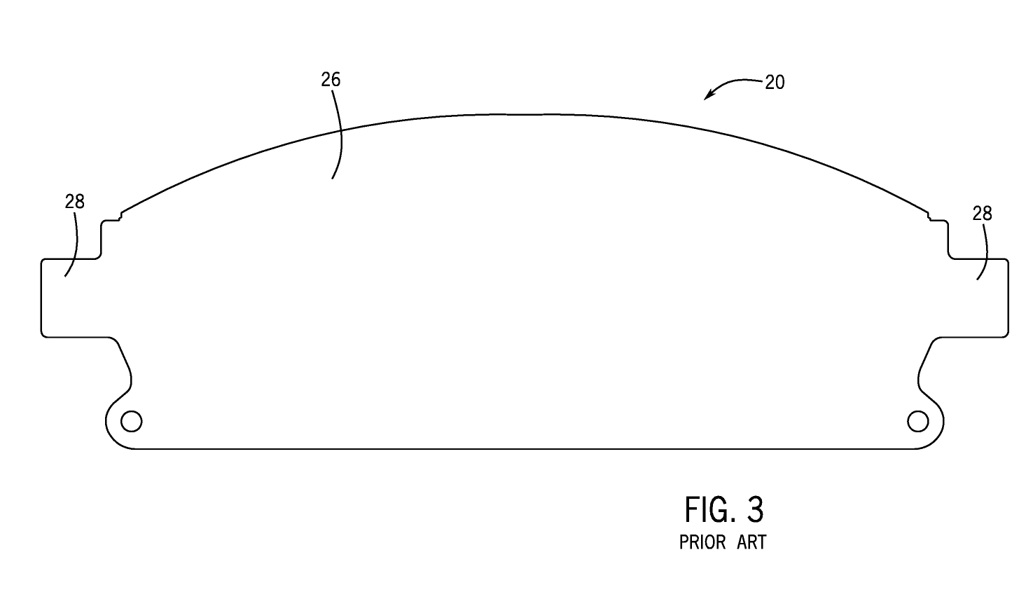

As seen in the front view of braking pad 20 in FIG. 2, each brake pad 20 has on its front side a brake lining 24 which is, in its installed position, arranged so as to press against the disc 11 during a braking event. The brake lining 24 is formed of a friction material, typically a ceramic material, a metallic or semi-metallic material, or a synthetic composite material. The brake lining 24 of the pad 20 is affixed to a backing plate 26 of the pad 20, as shown in the rear view of the braking pad 20 in FIG. 3. The backing plate 26 supports the brake lining 24 on a front face of the backing plate 26, which is formed on an opposite side to the rear face of the backing plate. The backing plate 26 typically is formed of metal.

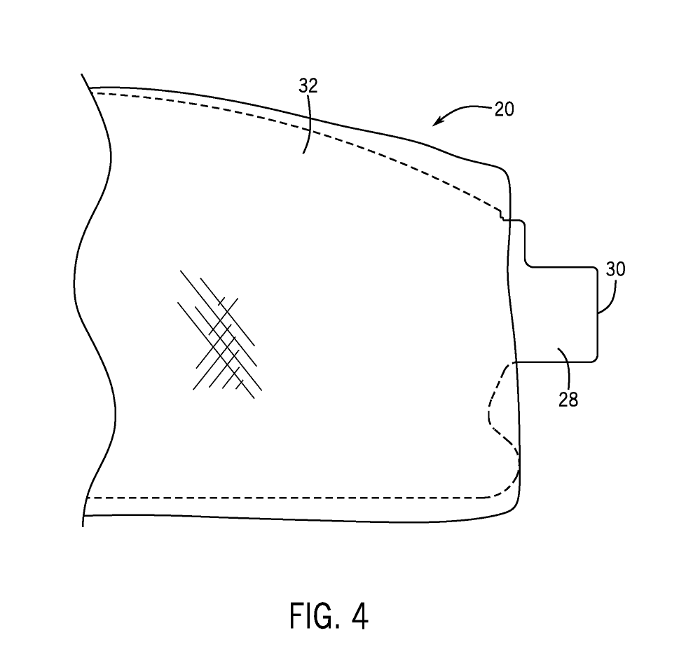

As shown in FIGS. 2-3, the pad 20 typically has a feature for engagement with a caliper. In FIGS. 2-3, the feature is a configuration that includes a tab 28, in the form of an ear, or other similar protruding element, that is formed as a part of the backing plate 26. In the depicted embodiment, at least one tab 28 extends laterally outwardly on each one of the left and right lateral sides of the backing plate 26. The outermost lateral surface or edge 30 of the tab 28 forms the outer periphery of the tab 28. The edge 30 of the tab 28 includes a top edge portion, bottom edge portion, and a side edge portion, as shown in FIG. 4.

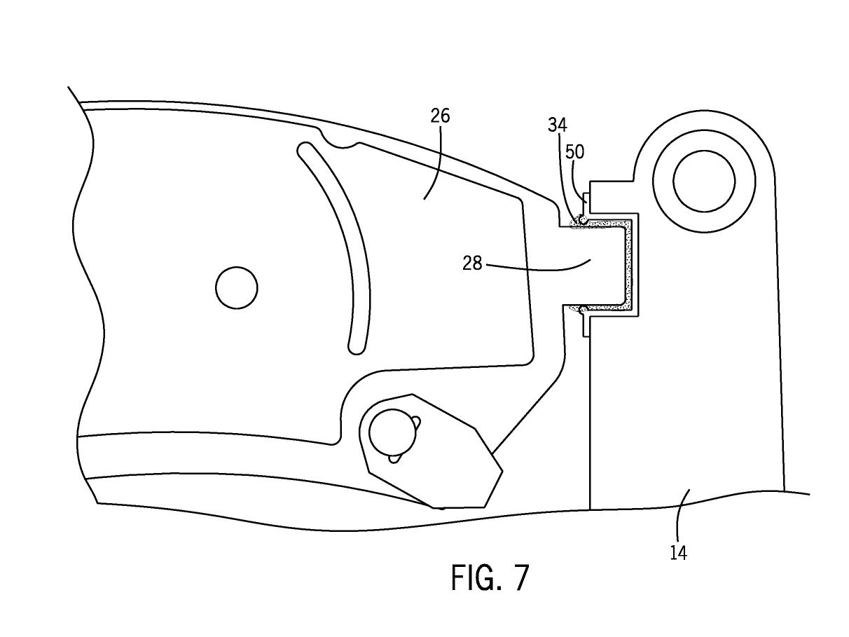

Each tab 28 is shaped and adapted to be inserted into and engaged with a mount 50 that is formed in the caliper 14 of the assembly 8, such that the edge 30 closely abuts the caliper mount. A typical caliper mount 50 is shown on a caliper 14 in FIG. 7. The caliper mount 50 is shaped and adapted to receive insertion of the tab 28 of a brake pad 20. The caliper mount 50 holds the tab 28 in a fixed engagement with the caliper 14, by a tight-fitting engagement between the inner surfaces of the caliper mount 50, or fingers of the caliper 14 that form the mount, and the outermost surface or edge 30 of the tab 28. The engagement by the mount holds the tab 28 and accordingly the pad 20 in position with respect to the disc 11. In some assemblies, the caliper mount is fitted with caliper adaptors that abut the edge 30 of the tab 28, and aid the mounting of the tab 28 in the caliper mount 50. In some assemblies, bolts or other affixation means secure the pad 20 to the caliper 14.

The inventors have investigated the problems associated with lack of lubrication at the point at which the brake pad 20 is engaged with the caliper mount 50. When a mechanic installing the pad 20 fails to properly lubricate all of the contact points between the pad 20 and the caliper 14, excessive noise and wear may occur. On the other hand, application of excess lubricant in the installation process can cause the lubricant to migrate into areas of the brake assembly where the lubricant interferes with the desired braking functions. The inventors have developed the following method and improved brake pad to address these and related problems.

In a representative embodiment of the method of manufacture, a brake pad 20 having a backing plate 26 that includes at least one tab 28 formed on the sides thereof is provided. In a preparation step, the brake pad 20 is masked. The masking step may preferably include applying a mask 32, in the nature of temporary protective covering such as a layer of fabric tape or a plastic mask. The mask is placed over at least those portions of the brake lining 24 and the backing plate 26 that abut the tab 28. The mask 32 is positioned on pad 20 such that the application of the lubricant and the sealant as described below will not result in the lubricant or sealant being applied to the masked portions of the brake pad 20 due to the coverage supplied by the mask 32. Thus the mask protects at least parts of the rear face of the backing plate 26 and at least parts of the front surface of the brake lining 24 from the application of lubricant or sealant during in the following steps. A typical placement of an applied mask 32 is shown in FIG. 4.

In a representative embodiment, the brake pad 20 bearing the mask 32 as shown in FIG. 4 is next subjected to a lubricant application step. In the lubricant application step, a bead or a thin extruded line of a viscous lubricant material is applied to the outer surface or edge 30 of the tab 28. The line of lubricant material preferably is applied only along the edge 30 of the tab in a line having an axis that extends essentially parallel to an axis of a line defined along the portions of the edge 30, such that excess lubricant is not applied to front or back surfaces of the tab 28 but only to the edge 30.

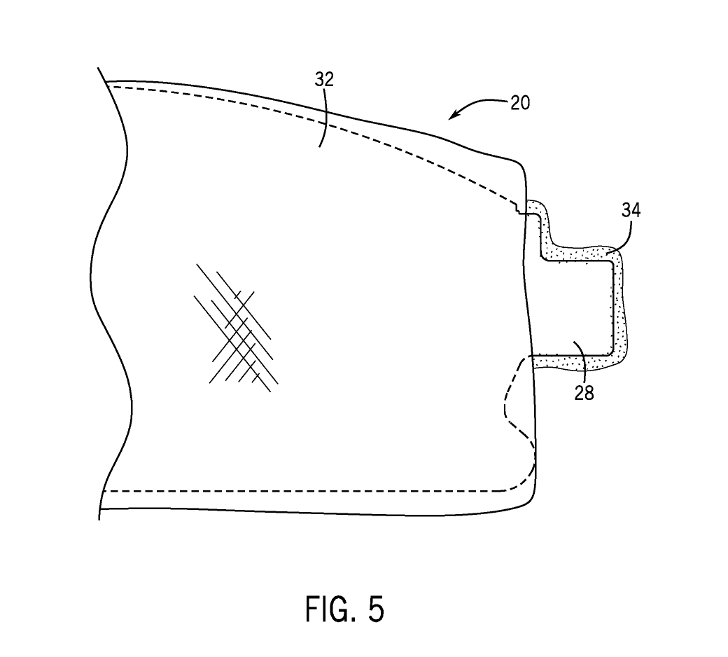

The line of lubricant so applied will form a lubricant layer 34 along the edge 30 of the tab 28 as depicted in FIG. 5. In an embodiment, the lubricant is applied in the layer 34 along all three of the top edge portion, bottom edge portion, and side edge portion of the tab 28. In an embodiment, the lubricant is applied to only one or only two of these three edge portions to conserve lubricant or to avoid undesired seepage of an excess of applied lubricant beyond the edge portions that will contact parts of the caliper 14, onto other parts of the pad 20. As shown in FIG. 5, in an embodiment, some of the lubricant also may be applied along the lateral edge of the backing plate 26 for a short distance beyond the end of the edge 30 of the tab 28, if needed to accommodate the shape of the caliper mount area of the caliper 14, so that lubricant layer 34 is applied in all metal-to-metal contact areas between the pad 20 and the caliper 14.

The lubricant material is, in a preferred embodiment, a high temperature compatible brake lubricant. The lubricant material may preferably be a synthetic-based formulation having a high solids content of friction reducing agents such as molybdenum disulfide or graphite. The lubricant in an embodiment may preferably be a dry-film type of lubricant applied from a tube or stick or prepared in a paste form.

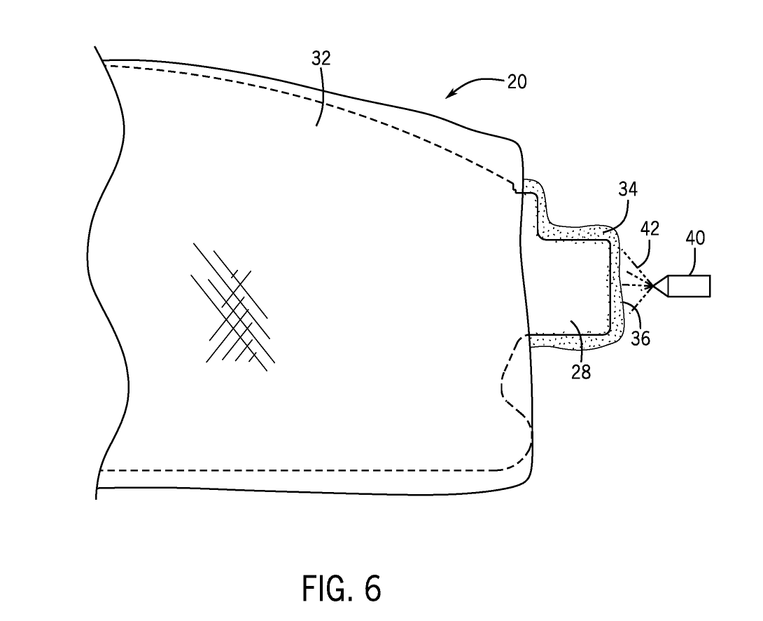

As shown in FIG. 6, after the lubricant layer 34 is applied, sealant material is applied over the lubricant. In a preferred embodiment, the sealant material may be applied by spraying a liquid sealant material onto the surface of the applied lubricant layer 34. This step is depicted in FIG. 6, where a sprayer 40 is used to apply the sealant material 42 in an aerosol spray form to the surface of the lubricant layer 34. The applied sealant layer is indicated with reference numeral 36 in FIG. 6. In an embodiment, the sealant material 42 is a lacquer clear coat applied over the lubricant layer 34 and permitted to dry or harden to form the sealant layer 36. The sealant layer 36 protects the lubricant layer 34 from being dislodged from its position on edge 30 during storage or shipment of the pad 20. As seen in FIG. 6, the mask 32 prevents overspray of the lacquer clear coat from reaching areas of the pad 20 other than the desired sealant application area, namely the lubricant layer 34 and the tab 28. In alternate embodiments, the sealant material may be applied in the form of a thin, flexible thermoplastic film, tape, or shield, instead of a spray-on form.

The sprayed-on sealant layer 36 is then dried or hardened onto the lubricant layer 34, thereby forming a protective seal over the lubricant layer 34 such that the lubricant layer 34 is not disturbed by contact during packing and shipment of the pad 20. The protective mask layer 32 may be removed if desired after the sealant application step.

After packaging and shipment, the pad is installed in an automobile as follows. The replacement disc brake pad 20 is mounted on the caliper 14 of the automobile as shown in an embodiment as depicted in FIG. 7. In this embodiment, the tab portion 28 of the pad 20 is inserted into the caliper mount 50 formed on the caliper bracket, which supports the pad 20 for in and out movement to frictionally engage the disc 11 in a braking event in the automobile, in a conventional manner. During insertion of the improved disc brake pad 20 into the mount 50, the close fit between the tab 28 and the mount 50 causes sufficient abrasion and sufficient pressure to be exerted upon the sealant layer 36 such that the sealant layer 36 will rupture. The rupture will cause the release of the lubricant material in the area of the points of contact between the edge 30 of the tab 28 and the edges of the mount 50. This applies the lubricant material exactly where it is needed, and only where it is needed.

Although the description above is made with reference to only one tab 28, it is understood that typical brake pad configurations may include a number of features for connection to the caliper, such as a number of tabs, or a number of other formations such as slots, bolt holes, notches, or protrusions, that may serve as the points of engagement between the pad and the caliper. The invention is applicable to any contact point between a disc brake pad and a caliper on which it is mounted where lubrication is desirable. Preferably the lubrication method and improved configuration described herein are applied to all such points of engagement.

In an embodiment where the sealant layer is a thermoplastic film instead of a lacquer clear coat, the mechanic installing the pad 20 may, instead of relying upon rupture of the sealant layer, peel off, break off, or otherwise remove the film manually, exposing the lubricant layer 34. Again, this results in application of the lubricant material exactly where it is needed, and only where it is needed.

While this invention has been described in connection with its use for pre-lubricating disc brake pads for original automotive equipment, replacement, replacement brake assembly kits, and repairs, it should be understood that the invention can be applied in any mechanical, commercial or industrial setting where precise placement of a lubricant is needed or desirable on any metal component that will abut or be engaged with a second component. Automobile manufacturers purchase many parts and assemblies from third party manufacturers and pre-lubrication can simplify and speed up final assembly of original equipment. Brake shoes would be a typical example. There are many contact points in a drum brake system for which lubrication might be overlooked during installation. Brake calipers could be pre-lubricated at the brake caliper contact points. Other brake hardware also could be pre-lubricated in accord with the invention.

The present invention can also be used in many other mechanical, industrial or commercial settings. For example, pre-lubricated bolts/studs manufactured according to the method can be shipped for immediate installation. Proper lubrication of certain bolts such as head bolts/studs, main bolts/studs, and rod bolts/studs ensures proper bolt torque. Proper torque is essential for proper assembly of, for example, engines, transmissions, CV axles, and hub assemblies.

The inventors have determined that substantial benefits of simplicity of manufacture and low cost reside in a very simple embodiment of the invention consisting of or consisting essentially of the device or the method as described herein. Thus, embodiments of the invention contemplate exclusion of steps, features, parts, and components other those set forth herein, and contemplate in some embodiments the exclusion of certain steps, features, parts and components that are set forth herein.

Thus, herein described is a method of manufacturing a disc brake pad, comprising providing the brake pad, applying a lubricant layer to the brake pad at a portion of the brake pad that is configured to engage with a caliper of a disc brake assembly; and applying a sealant layer to cover the lubricant layer. In an embodiment, the invention further includes applying a mask to portions of the brake pad other than the portion configured to engage with the caliper, before applying the lubricant layer. In an embodiment, the invention further includes drying the sealant layer after applying the sealant layer. In an embodiment, the portion configured to engage with the caliper is an edge of a tab extending outwardly on a lateral side of a backing plate of the brake pad. In an embodiment, the sealant layer is formed by spraying a sealant material onto the lubricant layer. In embodiments, the sealant material is a lacquer. In an embodiment, the sealant layer is a thermoplastic film, and/or the mask is comprised of a fabric tape.

Disclosed is a pre-lubricated disc brake pad, comprising a brake lining; a backing plate; a lubricant layer; and a sealant layer, wherein the backing plate comprises a portion that is configured to engage with a caliper of a disc brake assembly, the lubricant layer is formed on the portion configured to engage with the caliper, and the sealant layer is formed on the lubricant layer so as to form a seal that covers the lubricant layer. In an embodiment, the portion configured to engage with the caliper is an edge of a tab extending outwardly on a lateral side of a backing plate of the brake pad. In an embodiment, the sealant layer is a lacquer. In an embodiment, the sealant layer is formed by spraying the lacquer onto the lubricant layer. In an embodiment, the sealant layer is a thermoplastic film. In an embodiment, the backing plate is a metal backing plate.

Disclosed is a disc brake repair kit, comprising at least one disc brake rotor; and at least one disc brake pad, the disc brake pad comprising a brake lining; a backing plate; a lubricant layer; and a sealant layer, wherein the backing plate comprises a portion that is configured to engage with a caliper of a disc brake assembly, the lubricant layer is formed on the portion configured to engage with the caliper, and the sealant layer is formed on the lubricant layer so as to form a seal that covers the lubricant layer. In an embodiment, the portion configured to engage with the caliper is an edge of a tab extending outwardly on a lateral side of a backing plate of the brake pad. In an embodiment, the sealant layer is a lacquer. In an embodiment, the sealant layer is formed by spraying the lacquer onto the lubricant layer. In an embodiment, the sealant layer is a thermoplastic film. In an embodiment, the backing plate is a metal backing plate.

Also disclosed is a pre-lubricated metal component, comprising a metal body having a portion that is configured to engage with a second component; a lubricant layer; and a sealant layer, wherein the lubricant layer is formed on the portion of the metal body configured to engage with the second component, and the sealant layer is formed on the lubricant layer so as to form a seal that covers the lubricant layer.

The foregoing detailed description has been given for clearness of understanding only and no unnecessary limitations should be understood therefrom. While the invention has been illustrated and described in detail in the drawings and foregoing description, the same is to be considered as illustrative and not restrictive in character, it being understood that only certain exemplary embodiments have been shown and described and that all changes and modifications that come within the spirit of the invention are desired to be protected. It should be understood that while the use of words such as preferable, preferably, preferred or more preferred utilized in the description above indicate that the feature so described may be more desirable, it nonetheless may not be necessary, and embodiments lacking the same and excluding the same also may be contemplated as within the scope of the invention. The above-described embodiments of the present invention have been provided to illustrate various aspects of the invention. However, it is to be understood that different aspect of the invention shown in different specific embodiments can be combined to provide other embodiments of the invention. In reading the claims, it is intended that when words such as “a,” an,” “at least one,” or “at least one portion” are used there is no intention to limit the claim to only one item unless specifically stated to the contrary in the claim. Reference to terms in the singular in the specification also may contemplate the plural form of the terms. When the language “at least a portion” and/or “a portion” or “portions” is used the item can include a portion and/or the entire item unless specifically stated to the contrary.

1. A method of manufacturing a disc brake pad, comprising:
providing the brake pad, applying a lubricant layer to the brake pad at a portion of the brake pad that is configured to engage with a caliper of a disc brake assembly; and
applying a sealant layer to cover the lubricant layer.

2. The method according to claim 1, further comprising applying a mask to portions of the brake pad other than the portion configured to engage with the caliper, before applying the lubricant layer.

3. The method according to claim 1, further comprising drying the sealant layer after applying the sealant layer.

4. The method according to claim 1, wherein the portion configured to engage with the caliper is an edge of a tab extending outwardly on a lateral side of a backing plate of the brake pad.

5. The method according to claim 1, wherein the sealant layer is formed by spraying a sealant material onto the lubricant layer.

6. The method according to claim 5, wherein the sealant material is a lacquer.

7. The method according to claim 1, wherein the sealant layer is a thermoplastic film.

8. The method according to claim 2, wherein the mask is comprised of a fabric tape.

9. A pre-lubricated disc brake pad, comprising:
a brake lining;
a backing plate;
a lubricant layer; and
a sealant layer,
wherein the backing plate comprises a portion that is configured to engage with a caliper of a disc brake assembly,
the lubricant layer is formed on the portion configured to engage with the caliper, and
the sealant layer is formed on the lubricant layer so as to form a seal that covers the lubricant layer.

10. The pre-lubricated disc brake pad according to claim 9, wherein the portion configured to engage with the caliper is an edge of a tab extending outwardly on a lateral side of a backing plate of the brake pad.

11. The pre-lubricated disc brake pad according to claim 9, wherein the sealant layer is a lacquer.

12. The pre-lubricated disc brake pad according to claim 11, wherein the sealant layer is formed by spraying the lacquer onto the lubricant layer.

13. The pre-lubricated disc brake pad according to claim 9, wherein the sealant layer is a thermoplastic film.

14. The pre-lubricated disc brake pad according to claim 10, wherein the backing plate is a metal backing plate.

15. A disc brake repair kit, comprising:
at least one disc brake rotor; and
at least one disc brake pad, the disc brake pad comprising:
a brake lining;
a backing plate;
a lubricant layer; and
a sealant layer,
wherein the backing plate comprises a portion that is configured to engage with a caliper of a disc brake assembly,
the lubricant layer is formed on the portion configured to engage with the caliper, and
the sealant layer is formed on the lubricant layer so as to form a seal that covers the lubricant layer.

16. The kit according to claim 15, wherein the portion configured to engage with the caliper is an edge of a tab extending outwardly on a lateral side of a backing plate of the brake pad.

17. The kit according to claim 15, wherein the sealant layer is a lacquer.

18. The kit according to claim 17, wherein the sealant layer is formed by spraying the lacquer onto the lubricant layer.

19. The kit according to claim 15, wherein the sealant layer is a thermoplastic film.

20. The kit according to claim 15, wherein the backing plate is a metal backing plate.

21. A pre-lubricated metal component, comprising:
a metal body having a portion that is configured to engage with a second component;
a lubricant layer; and
a sealant layer,
wherein the lubricant layer is formed on the portion of the metal body configured to engage with the second component, and
the sealant layer is formed on the lubricant layer so as to form a seal that covers the lubricant layer.
